(19) United States
(12) Patent Application Publication
(10) Pub. No.: US 2008/0266542 A1
(43) Pub. Date: Oct. 30, 2008

(54) DISTANCE MEASURING DEVICE

(75) Inventors: Dezhong Yang, Nanjing (CN); Ming Chen, Nanjing (CN)

Correspondence Address: GREENBERG TRAURIG, LLP, 77 WEST WACKER DRIVE, SUITE 2500, CHICAGO, IL, 60601-1732, US

(73) Assignee: CHERVON LIMITED, Kwai Chung, NT. (HK)

(21) Appl. No.: 12/106,560

(22) Filed: Apr. 21, 2008

(30) Foreign Application Priority Data
Apr. 25, 2007 (CN) 200720036721.3

(51) Int. Cl. G01C 3/08; G09G 5/08; G06F 3/041

(52) U.S. Cl. 356/4.01; 345/173; 345/174

(57) ABSTRACT

A distance measuring device has a housing carrying a display, a distance measuring module, an inductive touch pad, a touch pad control circuit in communication with the touch pad, and a control circuit in communication with the display, the distance measuring module, and the touch pad control circuit. The touch pad control circuit provides signals to the control circuit representative of a touching of the touch pad.

### BACKGROUND

The following generally relates to distance measuring devices and, more particularly, relates to an electronic distance measuring device capable of precisely measuring a relatively longer distance.

In the art, processes and devices for electronic distance measurement are known. To this end, a radiation from an electronic distance measuring device is directed onto a plane to be measured. The radiation, which is reflected by the plane, is then detected by the distance measuring device. A distance between the distance measuring device and the plane is obtained by a series of processes and computing using information associated with the radiation and detected reflection. Conventional distance measuring devices are known as ultrasonic distance measuring devices, laser distance measuring devices, etc.

These distance measuring devices, particularly laser distance measuring devices, are usually used to perform a precise measuring operation, particularly when a high accuracy of a measuring result is rigidly required. Taking a laser distance measuring device as an example, a typical measuring process uses the following steps: a measuring button is activated and a laser beam is emitted out of the laser distance measuring device in a first step; the laser beam is aimed at an object in a far distance in a second step; and the measuring button is pressed again to obtain a measuring result in a final step. During this process, the laser beam will deflect from the aimed at object as a result of a force being applied upon the distance measuring device when the measuring button, which is typically constructed from a rubber material, is pressed with the result being the production of a measuring error. The measuring error can be a few millimeters, even a few multiple of ten millimeters, and the error produced during the process will be greater as the distance to be measured is longer.

### SUMMARY

The following describes an improved distance measuring device comprising a housing, a display, a distance measuring module, a control circuit, and a power supply device with the distance measuring module and the control circuit being located in the housing. The distance measuring device further comprises a touch pad and a touch pad control circuit connected with the touch pad. The touch pad may be an inductive touch pad, resistive touch pad, or capacitive touch pad.

A better appreciation of the objects, advantages, features, properties, and relationships of the disclosed distance measuring device will be obtained from the following detailed description and accompanying drawings which set forth illustrative embodiments which are indicative of the various ways in which the principles described hereinafter may be employed

### BRIEF DESCRIPTION OF THE DRAWINGS

For use in better understanding the distance measuring device described hereinafter reference may be had to the following drawings in which:

FIG. 1 is a perspective view of a preferred embodiment of a distance measuring device according to the present invention;

FIG. 2 illustrates a block diagram of the distance measuring device shown in FIG. 1;

FIG. 3 shows a schematic diagram of a single touch pad for use in the distance measuring device of FIG. 1;

FIG. 4 shows a schematic diagram of multiple touch pads for use in the distance measuring device of FIG. 1;

FIGS. 5A-5C show flow charts of control methods for controlling the touch pads of FIGS. 3 and 4; and

FIG. 6 shows a flow chart of one embodiment to achieve locking and unlocking of the touch pads of FIGS. 3 and 4.

### DETAILED DESCRIPTION

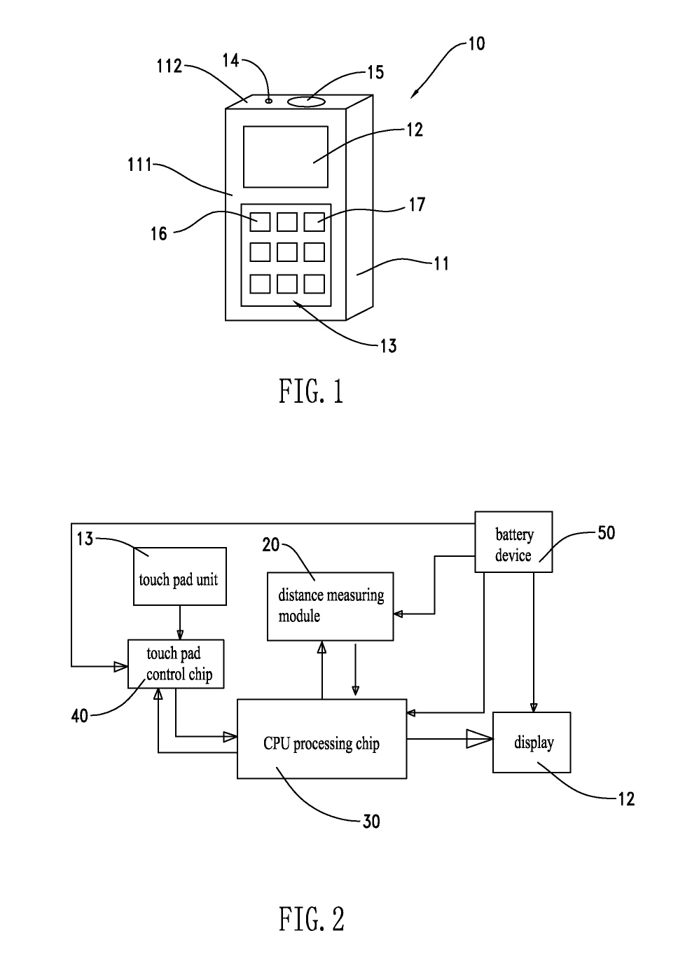

Referring to FIG. 1 and FIG. 2, a distance measuring device 10 has a housing 11, a LCD display 12 and a touch pad unit 13 disposed at one face 111 of the housing 11, and a emitting port 14 and a receiving port 15 for radiations located at another face 112 of the housing 11. A radiation is emitted from the emitting port 14 and a reflected radiation is received through the receiving port 15. A distance measuring module 20 and a control circuit board (not shown) are mounted in the housing 11, and a CPU processing chip 30 and a touch pad control chip 40 are integrated in the control circuit board. The distance measuring device 10 further comprises a battery or power device 50 for supplying power to the distance measuring module 20, the touch pad control chip 40, the CPU processing chip 30, and the display 12.

As illustrated in FIG. 2, signals produced as a result of touching the touch pad unit 13 are received by the touch pad control chip 40. When the CPU processing chip 30 inquires the touch pad control chip 40, signals received by the touch pad control chip 40 are transmitted to the CPU processing chip 30 to identify what of the touch pad was activated and the CPU processing chip 30 controls the distance measuring device for different operations corresponding to the identified touching of the touch pad. For example, if a “measuring” icon or key of the touch pad is touched, the CPU processing chip 30 will identify it and control the distance measuring module 20 to perform a measuring operation in which a distance is measured by the distance measuring module 20 and sent to the CPU processing chip 30 whereupon the CPU processing chip 30 controls the display 12 to display the measured distance.

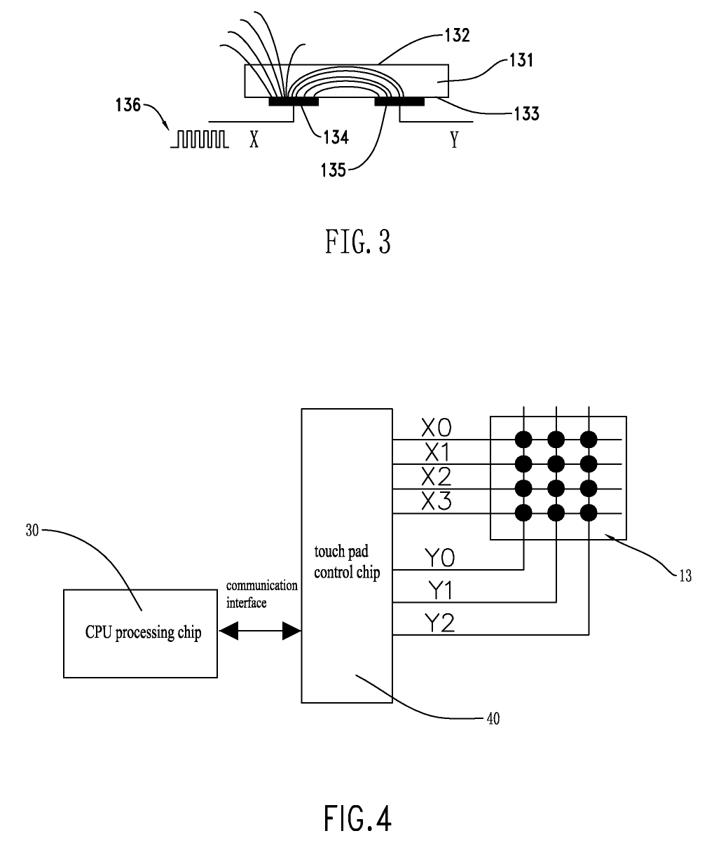

As shown in FIG. 3, the touch pad may be of the type currently utilized in devices such as mp3 players, mobile phones, computers, etc. Specifically, the touch pad may consist of a small panel 131 and two electrodes 134,135 that are mounted on the bottom surface 133 of the panel. A signal 136 of a certain frequency is sent to the electrode 134 through an X terminal and is received at a Y terminal through coupling of capacitances between the electrodes 134,135. When a top surface 132 of the panel 131 is touched by a finger of a human, part of the signal 136 sent from the X terminal will be absorbed by the body of the human so that the voltage at the Y terminal is changed. When the voltage is changed to a certain extent no signal will be received at the Y terminal which thereby functions to indicate that the touch pad should be identified as having been activated.

Referring to FIG. 4, multiple touch pads may be connected with the touch pad control chip 40 through signal lines. On the assumption that the signal output terminals of the touch pad control chip 40 are terminals X0˜X3, and the signal input terminals are terminals Y0˜Y2, then a 4 by 3 matrix keyboard is constituted. Signals may be sent from the output terminals X0˜X3 by time-sharing, namely, a signal with a high frequency is sent from only one of X0˜X3 ports at any time. When no touch pad is touched, signals will be received at all the input terminals Y0˜Y2 according to the principle of a single touch pad described above. When signals cannot be received at one of the input terminals Y0˜Y2, it illustrates that a touch pad is touched and the output terminal which did not send the signal will be identified (or those that did send a signal will be identified) and a code (X,Y) which represents the touch pad being touched is obtained. For example, if a touch pad (X2,Y2) is touched, signals will be received at all the input terminals Y0˜Y2 when output terminals X0,X1,X3 are scanned, but no signal will be received at the input terminal Y2 when output terminal X2 is scanned, thereby a code (X2,Y2) is determined. As seen from FIG. 4, there is a communication interface between the touch pad control chip 40 and the CPU processing chip 30 for signal transmission.

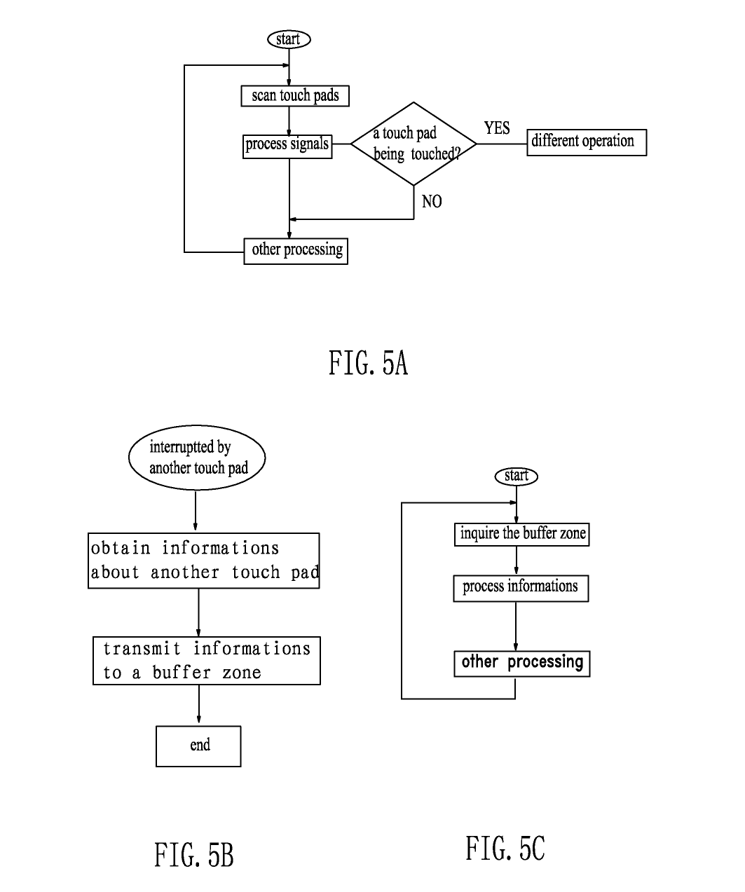

FIGS. 5A-5C are flow charts of exemplary control methods for controlling the touch pads. When the distance measuring device is activated the touch pads are scanned by the touch pad control chip and signals obtained during scanning by the touch pad control chip are sent to the CPU. A processing procedure is carried out by CPU to process the obtained signals to determine whether one of the touch pads is touched. If a touch pad is identified to be touched, a corresponding operation is performed. After completing the operation, the touch pads are scanned again. As seen in FIG. 5B, if another touch pad is touched while a processing procedure is being carried out by the CPU, an interrupting procedure will be activated. The touch pad control chip will obtain the information about the touching of another touch pad and transmit the information into a buffer zone. As seen in FIG. 5C, after completing the operation of the current processing procedure, the CPU will inquire the buffer zone and process according to the information saved in the buffer zone.

The principle of a sort of touch pad has been described above, but other touch pads suitable for touching operation can be applied to the distance measuring device in the present invention, such as a touch screen. This kind of touch screen comprises a resistive touch screen, capacitive touch screen, etc.

Since the touch pad is generally sensitive to ambient environment it may be probable to activate it by mistake. To avoid this situation, a device is set in the distance measuring device to prevent accidental activation. This device can be a removable protective cover (not shown). In a non-operation condition, the touch pads may be hidden under the protective cover and, in an operation condition, the touch pads would not be covered by the protective cover and exposed for operations by users.

There is another embodiment to prevent accidental activation. A function of locking of the keypad is added to the distance measuring device. This locking function can be realized through operating a locking key manually or can also be realized automatically through circuits or processes after a period of time during which no operation is done to the distance measuring device. Obviously, the two methods to realize the locking function described above can both be used in the distance measuring device. In this embodiment, a locking/unlocking key 16 (shown in FIG. 1) is pressed firstly and then a confirmation key 17 is pressed with a result that the keypad is locked manually and signal transmission is inhibited. To unlock the keypad manually, the locking/unlocking key 16 is pressed again and the confirmation key 17 is pressed subsequently. After unlocking the keypad, all of the touch pads can be activated again and the distance measuring device can be operated to measure a distance. In a preferred embodiment, the locking/unlocking key and the confirmation key can be used for other operations when the keypad is in an unlocked state. In addition, when the keypad is in a locked state, the display module may display information to teach the users to unlock the keypad if any key is touched. For example, when any key of the keypad is pressed, the information “press X key to unlock the keypad” is displayed, when the X key is pressed, information “press Y key to confirm the unlocking of keypad” is displayed, and when the Y key is pressed according to the information shown in the display the keypad is unlocked. Methods for locking and unlocking the keypad and methods for teaching the users to unlock the keypad described above are mature technology and widely used in the communication field, and can be used as reference in this invention. In addition, some other methods for locking and unlocking the keypad in the art can also be used as supplementary.

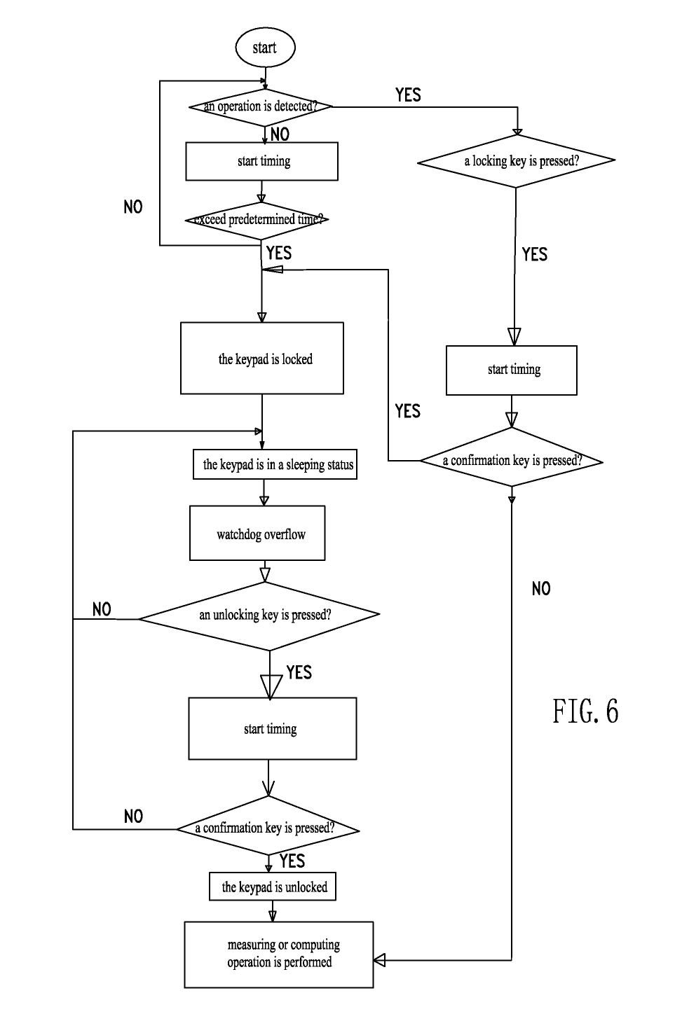

Referring to FIG. 6, the keypad may be locked when the CPU control chip detects that no operation is done to the keypad within a predetermined time period. The keypad may also be locked when the CPU control chip detects that a locking key is pressed in the unlocking state and a confirmation key is pressed subsequently within a predetermined time. But in some other operating processes such as measuring or computing, the locking key will not be identified by the CPU processing chip 30 as it is being pressed. After being locked, the keypad is in a sleeping status until a watchdog timing device overflows or other sources wake up the CPU control chip 30. When it is detected that an unlocking key is pressed, the CPU control chip starts timing and, if a confirmation key is pressed subsequently in a predetermined time, the keypad will be unlocked and a measuring or computing operation can be performed. The locking key and the unlocking key are preferred to be the same key, and the key for confirming the locking of the keypad and the key for confirming the unlocking of the keypad are also preferred to be the same key, such as the locking/unlocking key 16 and the confirmation key 17 shown in FIG. 7. And of course, several separate keys can also be used to realize the locking and unlocking of the keypad.

The above described preferred embodiments and drawings are intended to illuminate the principle of the present invention, but not to limit its scope. It can be easily understood for those of ordinary skilled in the art that many other modifications and variations of the preferred embodiments will be apparent and may be made without departing from the spirit and the scope of the invention as defined in the following claims.

What is claimed is:

1. A distance measuring device, comprising:
a housing carrying a display, a distance measuring module, a touch pad, a touch pad control circuit in communication with the touch pad, and a control circuit in communication with the display, the distance measuring module, and the touch pad control circuit wherein the touch pad control circuit provides signals to the control circuit representative of a touching of the touch pad.

2. The distance measuring device as claimed in claim 1, wherein the distance measuring device further comprises an emitting port for emitting a measuring radiation and a receiving port for receiving a reflected measuring radiation both associated with the distance measuring module.

3. The distance measuring device as claimed in claim 2, wherein the measuring radiation emitted from the emitting port and received by the receiving port is a laser beam.

4. The distance measuring device as claimed in claim 1, wherein the touch pad control circuit and said control circuit are connected by signal lines.

5. The distance measuring device as claimed in claim 4, wherein the touch pad comprises a panel and an electrode device which contacts to one face of the panel.

6. The distance measuring device as claimed in claim 5, wherein the electrode device comprise a first electrode and a second electrode.

7. The distance measuring device as claimed in claim 1, wherein the touch pad is a touch screen.

8. The distance measuring device as claimed in claim 1, wherein the distance measuring device further comprises a protective cover for selectively covering the touch pad.

9. The distance measuring device as claimed in claim 1, wherein the distance measuring device further comprises a locking key for placing the distance measuring device into a locked state in which signal generation as a result of a touching of the keypad is inhibited and a confirmation key for confirming a locking of the keypad.

10. The distance measuring device as claimed in claim 1, wherein the distance measuring device further comprises an unlocking key for removing the locked state from the signal measuring device and a confirmation key for confirming an unlocking of the keypad.

11. A distance measuring device, comprising:
a housing;
a distance measuring module mounted in the housing;
a display mounted to the housing;
a control unit arranged in the housing in communication with the distance measuring module and the display; and
a power supply connected to the distance measuring module, the display, and the control unit;
wherein the distance measuring device further comprises a touch pad and a corresponding touch pad control unit which is electrically connected to the control unit of the distance measuring device.

12. The distance measuring device as claimed in claim 11, wherein the distance measuring device further comprising an emitting port for emitting a measuring radiation and a receiving port for receiving a reflected measuring beam both associated with the distance measuring module.

13. The distance measuring device as claimed in claim 12, wherein the measuring radiation is a laser beam.

14. The distance measuring device as claimed in claim 11, wherein the touch pad comprises a panel and an electrode device which contacts to one surface of the panel.

15. The distance measuring device as claimed in claim 14, wherein the electrode device comprise a first electrode and a second electrode.

16. The distance measuring device as claimed in claim 11, wherein the touch pad is a touch screen.

17. The distance measuring device as claimed in claim 11, wherein the distance measuring device further comprises a protective cover for selectively covering the touch pad.

18. The distance measuring device as claimed in claim 11, wherein the distance measuring device further comprises a locking key for placing the distance measuring device into a locked state in which signal generation as a result of a touching of the keypad is inhibited and a confirmation key for confirming a locking of the keypad.

19. The distance measuring device as claimed in claim 11, wherein the distance measuring device further comprises an unlocking key for removing the locked state from the signal measuring device and a confirmation key for confirming an unlocking of the keypad.

20. The measuring device as claimed in claim 11, wherein the touch pad is a resistive touch screen.

21. The measuring device as claimed in claim 11, wherein the touch pad is a capacitive touch screen.
